(19) United States
(12) Patent Application Publication
(10) Pub. No.: US 2024/0103150 A1
(43) Pub. Date: Mar. 28, 2024

(54) LASER RADAR DEVICE

(71) Applicant: MITSUBISHI ELECTRIC CORPORATION, Tokyo (JP)

(72) Inventors: Junia NOMURA, Tokyo (JP); Yusuke ITO, Tokyo (JP); Takayuki YANAGISAWA, Tokyo (JP)

(73) Assignee: MITSUBISHI ELECTRIC CORPORATION, Tokyo (JP)

(21) Appl. No.: 18/519,195

(22) Filed: Nov. 27, 2023

Related U.S. Application Data
(63) Continuation of application No. PCT/JP2021/024659, filed on Jun. 30, 2021.

(51) Int. Cl. G01S 13/10; G01S 7/02; G01S 7/40

(52) U.S. Cl. CPC G01S 13/103; G01S 7/024; G01S 7/4013

(57) ABSTRACT

A laser radar device includes: a light source unit that outputs a plurality of intensity modulation pulses by periodically intensity-modulating laser light using intensity modulation signals having different frequencies; a telescope that transmits the plurality of intensity modulation pulses to a target and receives reflected light from the target as reception light; a light receiving unit that generates a reception electrical signal by photoelectrically converting the reception light; and a signal processing unit that calculates a distance and a physical property parameter of the target on the basis of the reception electrical signal.

### CROSS REFERENCE TO RELATED APPLICATIONS

This application is a Continuation of PCT International Application No. PCT/JP2021/024659 filed on Jun. 30, 2021, which is hereby expressly incorporated by reference into the present application.

### TECHNICAL FIELD

The present disclosure relates to a laser radar device.

### BACKGROUND ART

As a method of distance measurement by a laser radar device, there is a method called an intensity modulation pulse time of flight (ToF) system. The intensity modulation pulse ToF system refers to a method, among pulse ToF systems for obtaining a distance to a target from a pulse flight time from light emission start to light reception, for calculating a position of a hard target HT present in a volume target VT having strong scattering by extracting a reflection signal (HT signal) from the hard target HT by increasing a signal-to-noise ratio (SNR) of the HT signal by applying periodic intensity modulation to a light pulse. Non-Patent Literature 1 relates to the intensity modulation pulse ToF system, and Non-Patent Literature 1 describes an apparatus that identifies a hard target HT in a volume target VT using a pulse generated by a pulse multiplexing and demultiplexing system and intensity-modulated at a pseudo single intensity modulation frequency.

### CITATION LIST

### Non-Patent Literature

Non-Patent Literature 1: L. J. Mullen, A. J. C. Vieira, P. R. Herezfeld and V. M. Contarino, “Application of RADAR technology to aerial LIDAR systems for enhancement of shallow underwater target detection,” in IEEE Transactions on Microwave Theory and Techniques, vol. 43, no. 9, pp. 2370-2377, September 1995, doi:10.1109/22.414591.

### SUMMARY OF INVENTION

### Technical Problem

According to the technique described in Non-Patent Literature 1, although a position of a target can be calculated, there is a problem that a physical property parameter such as an extinction coefficient of the target cannot be calculated.

The present disclosure has been made in order to solve such a problem, and an object thereof is to provide a laser radar device of an intensity modulation pulse ToF system capable of calculating a physical property parameter such as an extinction coefficient of a target.

### Solution to Problem

A laser radar device according to an embodiment of the present disclosure includes: a light source circuit to output a plurality of intensity modulation pulses by periodically intensity-modulating laser light using intensity modulation signals having different frequencies; a telescope to transmit the plurality of intensity modulation pulses to a target and to receive reflected light from the target as reception light; a light receiver to generate a reception electrical signal by photoelectrically converting the reception light; and a signal processor to calculate a distance and an extinction coefficient of the target on a basis of the reception electrical signal.

### Advantageous Effects of Invention

The laser radar device according to the embodiments of the present disclosure can calculate a physical property parameter such as an extinction coefficient of a target.

### BRIEF DESCRIPTION OF DRAWINGS

FIG. 1 is a block diagram illustrating a configuration example of a laser radar device according to a first embodiment.

FIG. 2 is a block diagram illustrating a configuration example of a signal processing unit according to the first embodiment.

FIG. 3A is a diagram illustrating a configuration example of hardware of the signal processing unit.

FIG. 3B is a diagram illustrating another configuration example of hardware of the signal processing unit.

FIG. 4 is a flowchart illustrating operation of the laser radar device according to the first embodiment.

FIG. 5 is a schematic diagram of a pulse train.

FIG. 6A is a schematic diagram illustrating a waveform of a reception signal.

FIG. 6B is a schematic diagram of a reception signal waveform and frequency analysis.

FIG. 7 is a schematic diagram of a relationship between a distance and an SNR of a reception signal.

FIG. 8 is a schematic diagram of a signal processing method by a transfer function calculating unit.

FIGS. 9A and 9B are each a schematic diagram of an evaluated transfer function.

FIG. 10 is a schematic diagram illustrating distance characteristics of a physical property parameter.

FIG. 11 is a block diagram illustrating a configuration example of a laser radar device according to a second embodiment.

FIG. 12 is a block diagram illustrating a configuration example of an intensity modulation signal generating unit according to the second embodiment.

FIG. 13 is a flowchart illustrating operation of the laser radar device according to the second embodiment.

FIG. 14A is a schematic diagram of a pulse train. FIG. 14B is a schematic diagram of a transfer function of an evaluated hard target HT. FIG. 14C is a schematic diagram of a transfer function of an evaluated volume target VT.

FIG. 15A is a schematic diagram of a pulse train. FIG. 15B is a schematic diagram of a transfer function of an evaluated hard target HT. FIG. 15C is a schematic diagram of a transfer function of an evaluated volume target VT.

FIG. 16 is a block diagram illustrating a configuration example of a laser radar device according to a third embodiment.

FIG. 17 is a flowchart illustrating operation of the laser radar device according to the third embodiment.

FIG. 18 is a block diagram illustrating a configuration example of a laser radar device according to a fourth embodiment.

FIG. 19 is a block diagram illustrating a configuration example of a signal processing unit according to the fourth embodiment.

FIG. 20 is a flowchart illustrating operation of the laser radar device according to the fourth embodiment.

### DESCRIPTION OF EMBODIMENTS

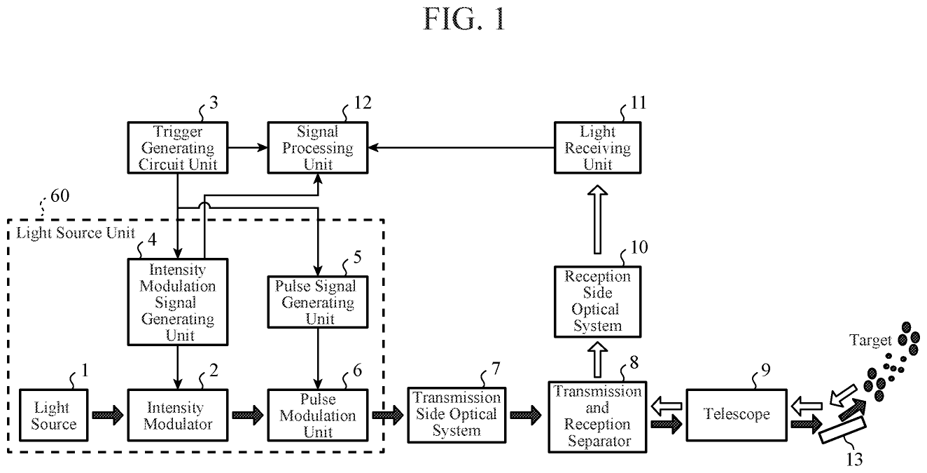

Hereinafter, various embodiments in the present disclosure will be described in detail with reference to FIGS. 1 to 17. Note that constituent elements denoted by the same or similar reference numerals throughout the drawings have the same or similar configurations or functions, and redundant description of such constituent elements will be omitted.

### First Embodiment

First, a laser radar device according to a first embodiment will be described with reference to FIGS. 1 to 10.

<Configuration>

A configuration example of the laser radar device according to the first embodiment of the present disclosure will be described with reference to FIGS. 1 to 3B. As illustrated in FIG. 1, the laser radar device according to the first embodiment includes, as an example, a light source 1, an intensity modulator 2, a trigger generating circuit unit 3, an intensity modulation signal generating unit 4, a pulse signal generating unit 5, a pulse modulation unit 6, a transmission side optical system 7, a transmission and reception separator 8, a telescope 9, a reception side optical system 10, a light receiving unit 11, a signal processing unit 12, and a scanner 13. The light source 1, the intensity modulator 2, the intensity modulation signal generating unit 4, the pulse signal generating unit 5, and the pulse modulation unit 6 constitute a light source unit 60. The transmission side optical system 7 and the reception side optical system 10 are selective components. In FIG. 1, black thick arrows indicate a flow of transmission light, white thick arrows indicate a flow of reception light, and thin arrows indicate a flow of an electrical signal. An optical path between the light source 1 and the intensity modulator 2, an optical path between the intensity modulator 2 and the pulse modulation unit 6, an optical path between the pulse modulation unit 6 and the transmission side optical system 7, an optical path between the transmission side optical system 7 and the transmission and reception separator 8, an optical path between the transmission and reception separator 8 and the telescope 9, an optical path between the transmission and reception separator 8 and the reception side optical system 10, and an optical path between the reception side optical system 10 and the light receiving unit 11 can be implemented by, for example, an optical fiber. There is a free space between the telescope 9 and the scanner 13. An electrical path through which an electrical signal flows is implemented by electrical wiring.

(Light Source)

The light source 1 is a light source that emits continuous wave laser light having a single frequency. The light source 1 is connected to the intensity modulator 2, and supplies the continuous wave laser light to the intensity modulator 2.

(Trigger Generating Circuit Unit)

The trigger generating circuit unit 3 is connected to the intensity modulation signal generating unit 4, the pulse signal generating unit 5, and the signal processing unit 12, generates a trigger signal (pulse irradiation trigger) for driving these components, and outputs the trigger signal to the intensity modulation signal generating unit 4, the pulse signal generating unit 5, and the signal processing unit 12. As the trigger generating circuit unit 3, for example, a pulse generator, a function generator, or a field-programmable gate array (FPGA) can be used.

(Intensity Modulation Signal Generating Unit 4)

The intensity modulation signal generating unit 4 generates an intensity modulation signal having a frequency fk over time on the basis of the trigger signal, k=1 to M (M is an integer equal to or more than 2). The intensity modulation signal generating unit 4 is connected to the intensity modulator 2 and the signal processing unit 12, and outputs the generated intensity modulation signal having a frequency fk to the intensity modulator 2 and the signal processing unit 12. The frequencies f1 to fM are set to be different from each other so that signals intensity-modulated at different frequencies are generated. Examples of a method for generating different frequencies of fk include: a method for generating a signal in which an offset frequency of δfk is applied to a frequency signal of f1 using a frequency mixer; and a method for generating different frequencies fk by multiplying a reference frequency by a multiplier or dividing the reference frequency by a frequency divider using a frequency of a signal generated by a reference signal generator as the reference frequency. Reference signals when intensity modulation frequency signals are generated do not need to be the same, and a reference signal may be prepared individually for each of intensity modulation frequencies.

(Pulse Signal Generating Unit)

The pulse signal generating unit 5 generates a pulse signal on the basis of the trigger signal. The pulse signal generating unit 5 is connected to the pulse modulation unit 6, and outputs the generated pulse signal to the pulse modulation unit 6.

(Intensity Modulator)

The intensity modulator 2 periodically intensity-modulates the continuous wave laser light from the light source 1 on the basis of the intensity modulation signal output from the intensity modulation signal generating unit 4. As the intensity modulator 2, for example, an optical attenuator, a semiconductor optical amplifier, an acousto-optic element, or an interferometer type intensity modulator using a phase modulator can be used. The intensity modulator 2 is connected to the pulse modulation unit 6, and outputs the intensity-modulated continuous wave laser light to the pulse modulation unit 6.

(Pulse Modulation Unit)

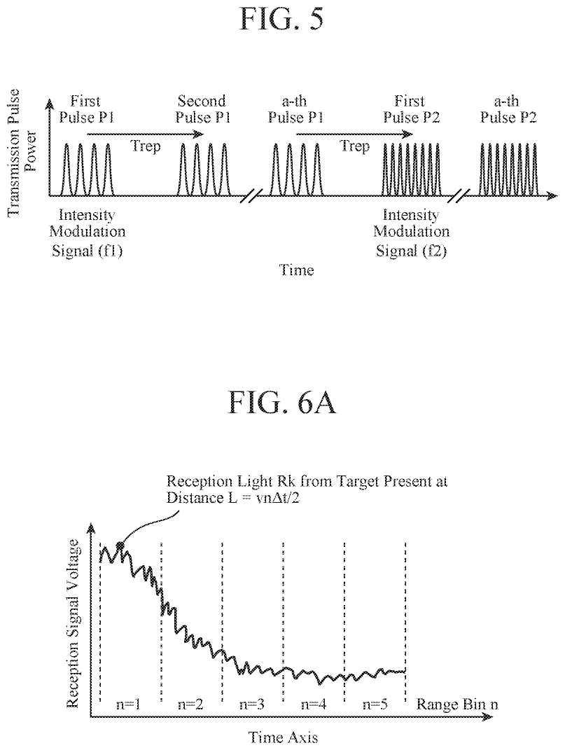

The pulse modulation unit 6 includes a pulse modulator, and pulse-modulates the intensity-modulated continuous wave laser light from the intensity modulator 2 into a pulse having a repetition period Trep and a pulse width δT on the basis of the pulse signal output from the pulse signal generating unit 5. As the pulse modulation unit 6, for example, an acousto-optic element or a phase modulator can be used. In order to obtain a high signal-to-noise ratio (SNR), the pulse modulation unit 6 may amplify optical power of the pulse-modulated laser light by including an optical amplifier. The pulse modulation unit 6 is connected to the transmission side optical system 7, and outputs the amplified laser light to the transmission side optical system 7. In such a manner as described above, the light source unit 60 periodically intensity-modulates the continuous wave laser light using intensity modulation signals having different frequencies, and outputs a plurality of intensity modulation pulses of different modulation frequencies. Note that “periodically intensity-modulate” means performing modulation in such a manner that optical power periodically changes. The periodically intensity-modulated pulse is, for example, a pulse P1 or a pulse P2 in FIG. 5. The pulse P1 indicates a state in which optical power periodically changes at a modulation frequency f1 while a maximum value of the optical power is kept constant. The pulse P2 indicates a state in which optical power periodically changes at a modulation frequency f2 while a maximum value of the optical power is kept constant.

(Transmission Side Optical System)

The transmission side optical system 7 shapes the pulse-modulated or amplified laser light from the pulse modulation unit 6 into laser light having a desired beam diameter and divergence angle. The transmission side optical system 7 includes a lens group including a concave surface and a convex surface. The transmission side optical system 7 may be a reflection type optical system using a mirror. Since the shaping of the laser light by the transmission side optical system 7 is performed in order to obtain a high SNR, the transmission side optical system 7 does not have to be disposed in a case where a sufficient SNR can be obtained without the transmission side optical system 7. The transmission side optical system 7 is connected to the transmission and reception separator 8, and outputs the shaped laser light to the transmission and reception separator 8.

(Transmission and Reception Separator)

The transmission and reception separator 8 is a separator that separates transmission light and reception light into predetermined ports. In a case where propagation of laser light between the transmission and reception separator 8 and another component is performed by spatial propagation, a polarizing beam splitter (PBS) can be used as the transmission and reception separator 8. In a case where propagation of laser light is performed by spatial propagation, the transmission and reception separator 8 is disposed between the transmission side optical system 7 and the telescope 9 and on an optical axis of transmission light. In a case where the transmission and reception separator 8 and another component are connected to each other by a fiber, a circulator can be used as the transmission and reception separator 8. The transmission and reception separator 8 outputs transmission light to the telescope 9 and outputs reception light to the reception side optical system 10.

(Telescope; Scanner)

The telescope 9 transmits transmission light in a desired direction via the scanner 13, and receives reception light that is reflected light from a target via the scanner 13. The telescope 9 includes a lens group including a concave surface and a convex surface. The telescope 9 may be a reflective type telescope using a mirror. The scanner 13 is rotated by a control unit (not illustrated) so as to face a predetermined direction. The telescope 9 outputs the reception light to the transmission and reception separator 8.

(Reception Side Optical System)

The reception side optical system 10 shapes the reception light from the transmission and reception separator 8 into light having a desired beam diameter and divergence angle. The reception side optical system 10 includes a lens group including a concave surface and a convex surface. The reception side optical system 10 may be a reflection type optical system using a mirror. Since the shaping by the reception side optical system 10 is performed in order to obtain a high SNR, the reception side optical system 10 does not have to be disposed in a case where a sufficient SNR can be obtained without the reception side optical system 10. The reception side optical system 10 is connected to the light receiving unit 11, and outputs the reception light to the light receiving unit 11.

(Light Receiving Unit)

The light receiving unit 11 generates a reception electrical signal by photoelectrically converting reception light. The light receiving unit 11 is connected to the signal processing unit 12, and outputs the reception electrical signal to the signal processing unit 12.

(Signal Processing Unit)

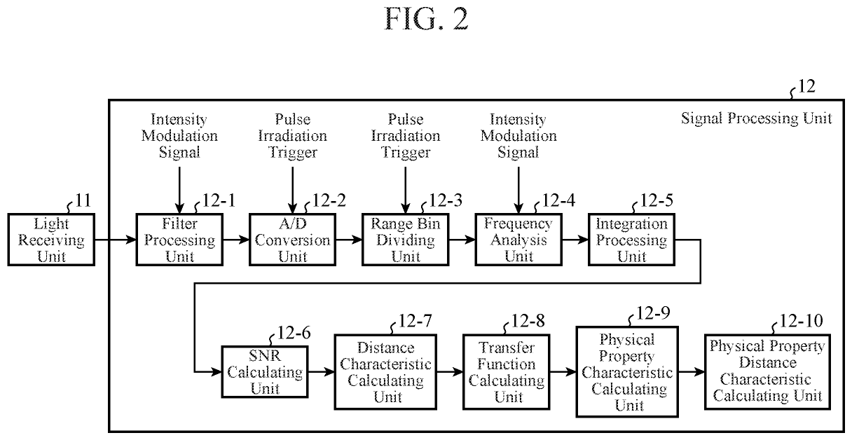

The signal processing unit 12 performs signal processing on the reception electrical signal, and calculates a physical property distance characteristic. Hereinafter, a configuration of the signal processing unit 12 will be described with reference to FIG. 2. As illustrated in FIG. 2, the signal processing unit 12 includes a filter processing unit 12-1, an A/D conversion unit 12-2, a range bin dividing unit 12-3, a frequency analysis unit 12-4, an integration processing unit 12-5, an SNR calculating unit 12-6, a distance characteristic calculating unit 12-7, a transfer function calculating unit 12-8, a physical property characteristic calculating unit 12-9, and a physical property distance characteristic calculating unit 12-10.

(Filter Processing Unit)

The filter processing unit 12-1 performs frequency filter processing on the reception electrical signal from the light receiving unit 11 on the basis of the intensity modulation signal having a frequency fk from the intensity modulation signal generating unit 4. The filter processing unit 12-1 is implemented by, for example, a band-pass filter having a center frequency fk (k=1, 2, 3, . . . M), and causes the reception electrical signal from the light receiving unit 11 within a pass band to pass therethrough. The filter processing unit 12-1 is connected to the A/D conversion unit 12-2, and outputs the filter-processed electrical signal to the A/D conversion unit 12-2. Note that the filter processing unit 12-1 may be disposed between the A/D conversion unit 12-2 and the integration processing unit 12-5.

(A/D Conversion Unit)

The AD conversion unit 12-2 performs AD conversion on the filter-processed electrical signal from the filter processing unit 12-1 on the basis of the trigger signal (pulse irradiation trigger) from the trigger generating circuit unit 3. The A/D conversion unit 12-2 is connected to the range bin dividing unit 12-3, and outputs the AD-converted digital signal to the range bin dividing unit 12-3.

(Range Bin Dividing Unit)

The range bin dividing unit 12-3 divides the AD-converted digital signal in a time direction with a width corresponding to a pulse width on the basis of the trigger signal (pulse irradiation trigger). The range bin dividing unit 12-3 is connected to the frequency analysis unit 12-4, and outputs the divided signal to the frequency analysis unit 12-4.

(Frequency Analysis Unit)

By performing fast Fourier transform (FFT) processing on the divided signal for each bin on the basis of the intensity modulation signal having a frequency fk from the intensity modulation signal generating unit 4, the frequency analysis unit 12-4 converts the signal for each bin into a spectrum. The frequency analysis unit 12-4 is connected to the integration processing unit 12-5, and outputs the spectrum to the integration processing unit 12-5.

(Integration Processing Unit)

The integration processing unit 12-5 integrates a plurality of spectra obtained from data of a plurality of shots having the same frequency fk in a spectrum space. The integration processing unit 12-5 is connected to the SNR calculating unit 12-6, and outputs the integrated spectrum to the SNR calculating unit 12-6.

(SNR Calculating Unit)

The SNR calculating unit 12-6 calculates an SNR of a reception signal at a certain time and at a certain intensity modulation frequency. The SNR calculating unit 12-6 is connected to the distance characteristic calculating unit 12-7, and outputs the calculated SNR to the distance characteristic calculating unit 12-7.

(Distance Characteristic Calculating Unit)

The distance characteristic calculating unit 12-7 calculates a relationship (distance characteristic: A-scope) between a distance and an SNR at a certain intensity modulation frequency. The distance characteristic calculating unit 12-7 calculates A-scopes for all of the intensity modulation frequencies f1 to fM. The distance characteristic calculating unit 12-7 is connected to the transfer function calculating unit 12-8, and outputs the plurality of calculated distance characteristics (A-scopes) to the transfer function calculating unit 12-8.

(Transfer Function Calculating Unit)

The transfer function calculating unit 12-8 calculates a transfer function of a target at a certain range bin from the plurality of distance characteristics (A-scopes) of the plurality of intensity modulation frequencies (f1 to fM) related to the range bin. In this manner, the transfer function calculating unit 12-8 analyzes transfer function characteristics of the target in the same range from frequency dependence of an SNR. The transfer function calculating unit 12-8 is connected to the physical property characteristic calculating unit 12-9, and outputs the calculated transfer function to the physical property characteristic calculating unit 12-9.

(Physical Property Characteristic Calculating Unit)

The physical property characteristic calculating unit 12-9 calculates a physical property characteristic of a target present in a range bin n by comparing the transfer function characteristic found from the transfer function at each range bin n obtained by the transfer function calculating unit 12-8 with a transfer function equation according to Equation (4) or Equation (6) described later or a transfer function equation according to an equation similar to these equations. In addition, the physical property characteristic calculating unit 12-9 may calculate a physical property characteristic of a target present in a range bin n by comparing the SNR at each range bin n obtained by the distance characteristic calculating unit 12-7 with an assumed SNR. The physical property characteristic calculating unit 12-9 is connected to the physical property distance characteristic calculating unit 12-10, and outputs the calculated physical property characteristic to the physical property distance characteristic calculating unit 12-10.

(Physical Property Distance Characteristic Calculating Unit)

For the physical property parameter data calculated by the physical property characteristic calculating unit 12-9, similarly to the distance characteristic calculating unit 12-7, the physical property distance characteristic calculating unit 12-10 calculates Δt=AD rate×range bin width×(n−1) from range bin information, an AD conversion rate, and a range bin width as illustrated in FIG. 10, converts Δt into a distance by L=v×Δt/2 (v is the speed of light), and outputs a physical property parameter graph for each distance.

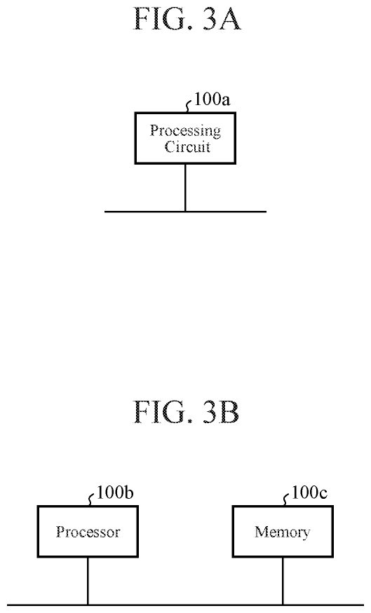

Next, a configuration example of hardware of the signal processing unit 12 will be described with reference to FIGS. 3A and 3B. As an example, as illustrated in FIG. 3A, the signal processing unit 12 is implemented by a processing circuit 100a. Examples of the processing circuit 100a include a single circuit, a composite circuit, a programmed processor, a parallel programmed processor, an application specific integrated circuit (ASIC), a field-programmable gate array (FPGA), and a combination thereof. Functions of the components of the signal processing unit 12 may be implemented by separate processing circuits, or the functions of the plurality of components may be implemented collectively by one processing circuit.

As another example, as illustrated in FIG. 3B, the signal processing unit 12 is implemented by a processor 100b and a memory 100c. The functions of the components included in the signal processing unit 12 are implemented by the processor 100b reading and executing a program stored in the memory 100c. The program is implemented as software, firmware, or a combination of software and firmware. Examples of the memory 100c include a nonvolatile or volatile semiconductor memory such as a random access memory (RAM), a read only memory (ROM), a flash memory, an erasable programmable read only memory (EPROM), or an electrically-EPROM (EEPROM), a magnetic disk, a flexible disk, an optical disc, a compact disc, a mini disc, and a DVD.

<Operation>

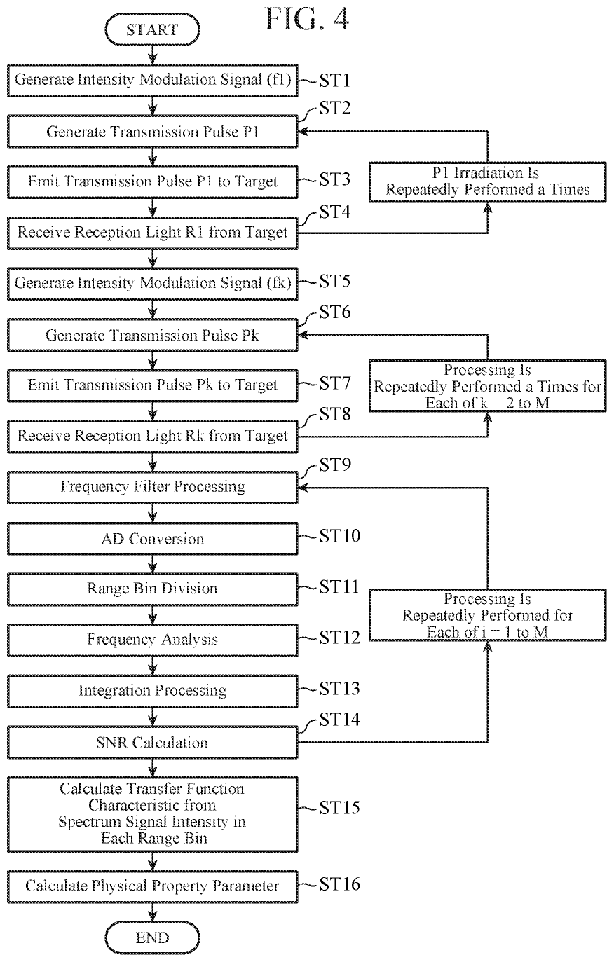

Next, operation of the laser radar device of the present first embodiment will be described with reference to FIGS. 4 to 10.

In step ST1, the intensity modulation signal generating unit 4 generates an intensity modulation signal having a frequency f1 on the basis of a trigger signal, and outputs the generated intensity modulation signal having the frequency f1 to the intensity modulator 2 and the signal processing unit 12. Subsequently, the intensity modulator 2 periodically intensity-modulates continuous wave laser light having a single frequency from the light source 1 with the intensity modulation signal having the frequency f1, and outputs the intensity-modulated continuous wave laser light to the pulse modulation unit 6.

In step ST2, the pulse modulation unit 6 pulse-modulates the intensity-modulated continuous wave laser light into pulse light P1 having a predetermined repetition period Trep and a pulse width ST (see pulse P1 in FIG. 5) on the basis of the pulse signal from the pulse signal generating unit 5, and outputs the pulse light P1 to the transmission side optical system 7. Hereinafter, a k-th transmission pulse signal is referred to as “Pk”. In addition, an intensity modulation frequency and a reception signal pulse from a target, corresponding to the transmission pulse Pk are referred to as fk and Rk, respectively.

In step ST3, the telescope 9 emits the pulse light P1 converted into light having a predetermined beam diameter and beam divergence angle by the transmission side optical system 7 toward the target via the scanner 13. The target is irradiated with the transmission light P1 emitted to the atmosphere, and reception light R1 is generated when the transmission light P1 is scattered by the target.

In step ST4, the telescope 9 receives the reception light R1 through an opening, and outputs the reception light R1 to the transmission and reception separator 8. The reception light R1 is transmitted to the reception side optical system 10 via the transmission and reception separator 8. The reception light R1 is converted into light having a predetermined beam diameter and beam divergence angle by the reception side optical system 10, and then transmitted to the light receiving unit 11. The reception light R1 is converted into a reception electrical signal by the light receiving unit 11, and the reception electrical signal is transmitted to the signal processing unit 12.

The laser radar device repeats the transmission and reception processing in steps ST2 to ST4 described above a times. a is an integer equal to or more than 1, and is a design value. Hereinafter, this value of a is referred to as the number of times of pulse integration That is, a is the number of times of integration in the same intensity modulation pulse.

As illustrated in FIG. 5, after the target is irradiated with the pulse P1 a times and the repetition period Trep elapses, in step ST5, the intensity modulation signal generating unit 4 generates an intensity modulation signal having a frequency f2 on the basis of a trigger signal, and outputs the generated intensity modulation signal having the frequency f2 to the intensity modulator 2 and the signal processing unit 12. Subsequently, the intensity modulator 2 periodically intensity-modulates continuous wave laser light having a single frequency from the light source 1 with the intensity modulation signal having the frequency f2, and outputs the intensity-modulated continuous wave laser light to the pulse modulation unit 6.

In step ST6, the pulse modulation unit 6 generates pulse light P2 different from the pulse light P1 by pulse-modulating the intensity-modulated continuous wave laser light on the basis of the pulse signal from the pulse signal generating unit 5 (see pulse P2 in FIG. 5), and outputs the generated pulse light P2 to the transmission side optical system 7.

In step ST7, the telescope 9 emits the pulse light P2 converted into light having a predetermined beam diameter and beam divergence angle by the transmission side optical system 7 toward the target via the scanner 13. The target is irradiated with the transmission light P2 emitted to the atmosphere, and reception light R2 is generated when the transmission light P2 is scattered by the target.

In step ST8, the telescope 9 receives the reception light R2 through an opening, and outputs the reception light R2 to the transmission and reception separator 8. The reception light R2 is transmitted to the reception side optical system 10 via the transmission and reception separator 8. The reception light R2 is converted into light having a predetermined beam diameter and beam divergence angle by the reception side optical system 10, and then transmitted to the light receiving unit 11. The reception light R2 is converted into a reception electrical signal by the light receiving unit 11, and the reception electrical signal is transmitted to the signal processing unit 12.

The laser radar device performs the processing in step ST5 until k reaches k=M. and repeats the processing in steps ST6 to ST8 a times for each value of k. Through the above operation, each of the reception light R1 to the reception light RM is received a times.

Next, signal processing according to steps ST9 to ST14 will be described. The signal processing may be performed every time each reception light is obtained subsequent to step ST4, or may be performed after all of the reception light R1 to the reception light RM is obtained subsequent to step ST8. Hereinafter, the signal processing according to steps ST9 to ST14 will be described on the basis of a case where the signal processing is performed after all of the reception light R1 to the reception light RM is obtained.

In step ST9, the filter processing unit 12-1 obtains an electrical signal corresponding to each modulation frequency by performing frequency filter processing on reception signals of all of reception light (R1 and Rk) on the basis of the intensity modulation signal having a frequency fk from the intensity modulation signal generating unit 4.

In step ST10, the A/D conversion unit 12-2 performs AD conversion on the reception signal of the reception light Rk. The A/D conversion unit 12-2 uses the trigger signal from the trigger generating circuit unit 3 as a start trigger of the AD conversion. Therefore, a start time of the AD conversion substantially coincides with a timing at which a transmission pulse is transmitted, and the AD conversion is continued for a predetermined period or until the next transmission pulse is generated. A signal that undergoes AD conversion after ΔT from start of the AD conversion corresponds to a reception signal from a target located in space separated by a distance L=v×ΔT/2 (v is the speed of light). The digitized reception signal corresponds to one pulse.

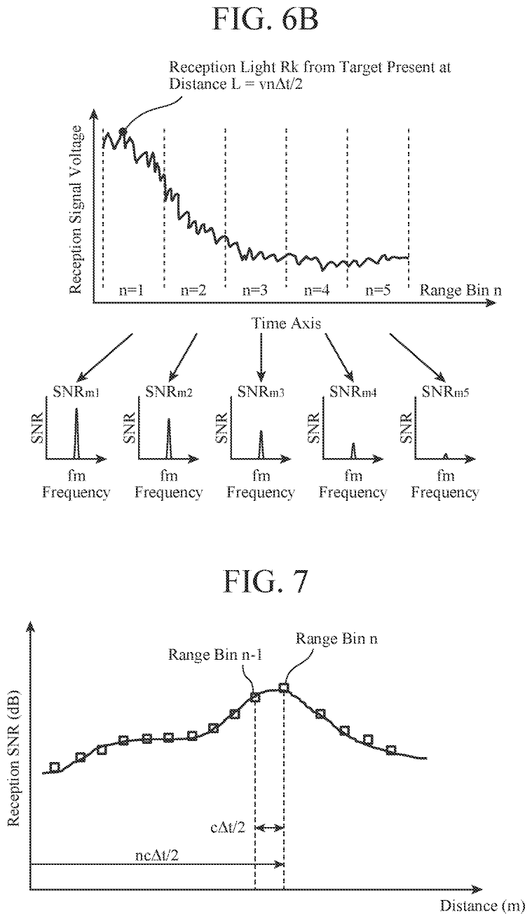

In step ST11, the range bin dividing unit 12-3 divides the digitized reception signal into signals for respective range bins. A range bin width is divided so as to correspond to a pulse width, and the pulse width is determined by design. FIG. 6A illustrates a temporal change of a reception signal obtained by receiving the reception light Rk from a target irradiated with the pulse transmission light Pk for one pulse. n represents a label of a divided range bin, and a label with a smaller value of n indicates a reflection signal from a closer vicinity.

In step ST12, the frequency analysis unit 12-4 converts the reception signals divided for respective range bins into spectrum signals by performing FFT on the reception signals, and outputs the obtained spectrum signals to the integration processing unit 12-5. A spectrum obtained by performing FFT on the reception signal of the reception light Rk corresponding to the transmission pulse Pk (modulation frequency fk) is affected by a frequency shift derived from a target or an environment, but substantially coincides with a modulation frequency within a reception bandwidth B. Hereinafter, the reception spectrum corresponding to the modulation frequency fk is referred to as fm. The reception bandwidth B is an assumed frequency shift width determined by a target moving speed or an ambient environment.

In step ST13, as illustrated in FIG. 6B, the integration processing unit 12-5 integrates the spectrum signal obtained by performing FFT on the signal of each range bin a times.

In step ST14, the SNR calculating unit 12-6 calculates an SNR of the spectrum fm of the reception signal by calculating a ratio between a peak intensity and an out-of-band noise. The SNR calculating unit 12-6 outputs the integrated spectrum fm and information of an SNR in each range bin to the distance characteristic calculating unit 12-7.

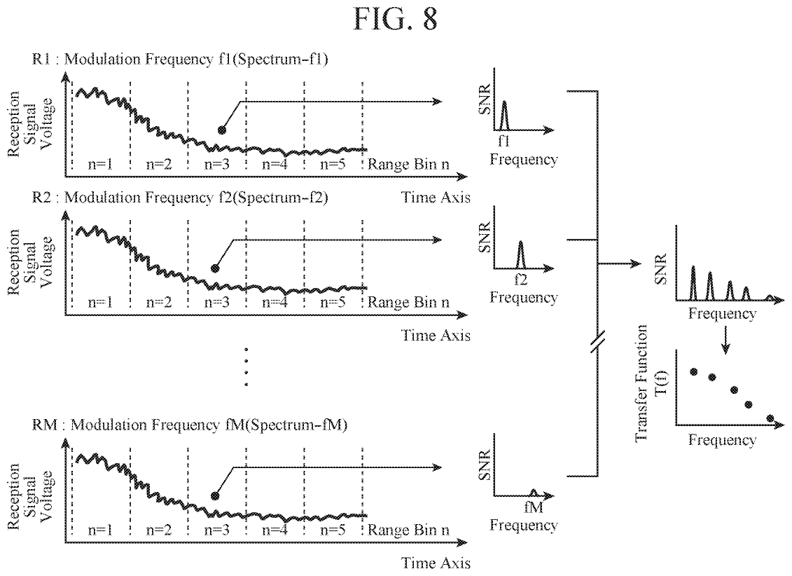

In step ST15, the distance characteristic calculating unit 12-7 calculates an A-scope which is a graph indicating an SNR for each distance. As illustrated in FIG. 7, information of an SNR in an any range bin n is collected for the spectra f1 to fM. The distance characteristic calculating unit 12-7 calculates Δt=AD rate×range bin width×(n−1) from range bin information, an AD conversion rate, and a range bin width, converts Δt into a distance by L=v×Δt/2 (v is the speed of light), and calculates an A-scope. Hereinafter, an SNR at a range bin n in a spectrum fm is referred to as an SNRmn. In addition, as illustrated in FIG. 8, the transfer function calculating unit 12-8 performs data processing on SNRs of the spectra f1 to fM in each range bin n (n=1, 2, 3, . . . ) on the basis of information of an SNRmn, and obtains a transfer function (graph in which the vertical axis represents T and the horizontal axis represents a spectral frequency f) for each range bin. Note that FIG. 8 illustrates a specific example of obtaining a transfer function by arranging the SNRs of the spectra f1 to fM along the frequency axis for a range bin of n=3.

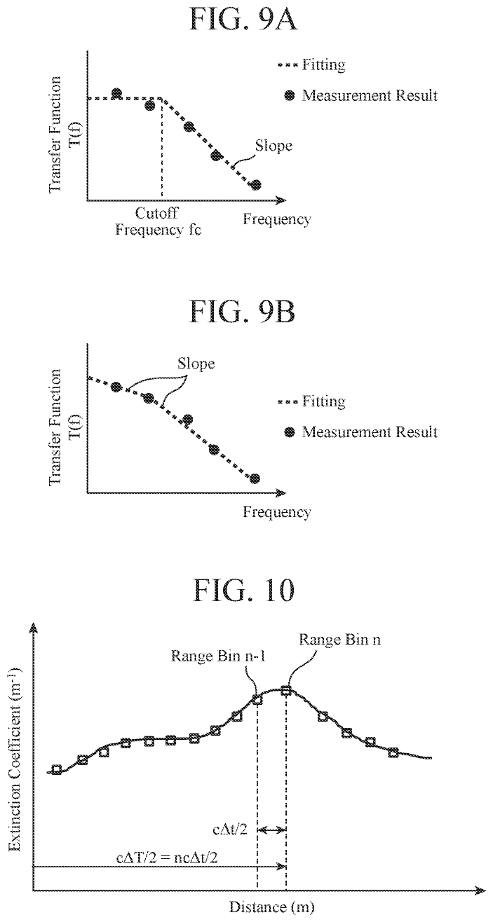

In step ST16, the physical property characteristic calculating unit 12-9 calculates a physical property characteristic of a target present in a range bin n. Specifically, the physical property characteristic calculating unit 12-9 calculates a physical property characteristic of a target present in a range bin n by comparing the transfer function characteristic determined from the transfer function at each range bin n obtained by the transfer function calculating unit 12-8 with a transfer function equation according to Equation (4) or Equation (6) below or a transfer function equation according to an equation similar to these equations. In addition, the physical property characteristic calculating unit 12-9 may calculate a physical property characteristic of a target present in a range bin n by comparing the SNR at each range bin n obtained by the distance characteristic calculating unit 12-7 with an assumed SNR Here, the transfer function characteristic is a whole shape of a graph as illustrated in FIG. 9A or 9B, a slope of the graph, a cutoff frequency fc when the graph is regarded as being equivalent to a transfer function of a low-pass filter, or the like.

In the intensity modulation pulse ToF system, reception signal power Pr from a target (extinction coefficient c, absorption coefficient α, backscattering coefficient β) present at a distance L (=vt/2) is expressed by the following Equation (1). In Equation (1), v represents a propagation speed in a volume target VT, t represents time, A represents a system coefficient, and Y represents a normalization constant. When Fourier transform of Equation (1) is performed under an assumption of Equation (2), Equation (3) is obtained.

$${P}_{r} ( t ) = A \times \frac{{e}^{- cvt}}{{v}^{2} {t}^{2}} \qquad ( 1 )$$

$${P}_{r} ( t ) \sim {Ye}^{- cvt} \qquad ( 2 )$$

$${P}_{r} ( ω ) = \frac{Y}{cv + j ω} \qquad ( 3 )$$

Therefore, when an intensity modulation pulse having an intensity modulation angular frequency ω=2πf is transmitted to a target, a modulation frequency ωₘ component of an obtained reception signal is expressed by Equation (4). A transfer function T(ω) of the target is expressed by Equation (4) under an assumption of Equation (2), which is equivalent to a case of a first-order low-pass filter (LPF).

$$\vert T ( ω ) \vert = \vert \frac{Y}{cv + j ω} \vert \qquad ( 4 )$$

The cutoff frequency fc of the transfer function is expressed by Equation (5) using an extinction coefficient c under an assumption of Equation (2).

$${f}_{c} = \frac{cv}{2 π} \qquad ( 5 )$$

For example, a cutoff frequency of a transfer function of a scattering medium (VT) having c=1 m⁻¹ and a refractive index n=1.3 corresponds to fc=37 MHz.

Strictly speaking, since L(t)=vt/2 in Equation (1), a more accurate transfer function of the target is expressed by the following Equation (6).

$$\vert T ( ω ) \vert = \vert {\int }_{0}^{∞} \frac{{Ae}^{- cvt}}{{v}^{2} {t}^{2}} {e}^{- i ω t} dt \vert \qquad ( 6 )$$

A physical property parameter (for example, an extinction coefficient c) can be estimated by comparing a transfer function characteristic of the target calculated on the basis of a measurement result (the lower right diagram in FIG. 8) with the transfer function equation of Equation (4) or (6) or a transfer function equation similar to Equation (4) or (6). FIG. 9A illustrates fitting by the transfer function equation of Equation (4), and FIG. 9B illustrates fitting by the transfer function equation of Equation (6). For example, in a case of estimating the extinction coefficient c, the cutoff frequency fc is obtained by comparing the transfer function characteristic based on the measurement result with a transfer function equation such as Equation (4), and the extinction coefficient c is calculated from Equation (5).

In addition, for the physical property parameter data calculated by the physical property characteristic calculating unit 12-9, similarly to the distance characteristic calculating unit 12-7, the physical property distance characteristic calculating unit 12-10 calculates Δt=AD rate×range bin width×(n−1) from range bin information, an AD conversion rate, and a range bin width as illustrated in FIG. 10, converts Δt into a distance by L=v×Δt/2 (v is the speed of light), and outputs a physical property parameter graph for each distance.

The extinction coefficient c in Equation (1) is expressed by using an absorption coefficient α and a scattering coefficient b (or a backscattering coefficient β) as in the following Equation (7). Note that Ω is a solid angle of a transmission and reception optical system.

c=α+b=α+∫βdΩ (7)

As expressed by Equation (7), the extinction coefficient c has a correlation with two or more physical property parameters, and therefore, in a conventional technique, a certain relationship is assumed between these parameters. For example, in design of a laser sensor, the backscattering coefficient β and the extinction coefficient c are assumed to have a linear relationship, a ratio therebetween is represented by a lidar ratio S₁, and a relationship of the following Equation (8) is assumed.

c=S₁β (8)

The lidar ratio S₁ is determined by a particle size, a laser wavelength λ, a particle shape, and the like. By determining a measurement target and using the lidar ratio S₁ whose numerical value is determined by simulation or another measurement, and Equations (1) and (8), a backscattering coefficient of a target is calculated.

According to such a conventional method, in a case where physical property information of a measurement target is unknown, or in a case where measurement is performed in a special environment such as the sky or the sea, there is a problem that the assumption of Equation (8) cannot be used, or accuracy of a calculated physical property value decreases when Equation (8) is used.

By contrast, according to the method of the present disclosure, a physical property parameter can be estimated without specifically assuming a correlation between the physical property parameters required in the conventional technique.

<Effects>

Since the transfer function of the data output from the transfer function calculating unit 12-8 has information of an extinction coefficient, and the SNR output from the SNR calculating unit 12-6 has information of the extinction coefficient and a scattering coefficient, it is possible to detect the extinction coefficient and the scattering coefficient of a target independently by calculating a transfer function characteristic of the intensity modulation frequency fk in addition to the SNR for the pulse reception signal from the target present at a distance L as described above.

In a conventional laser radar device, there is a problem that it is impossible to calculate the extinction coefficient and the scattering coefficient independently, and usually, known target information is used, or a relationship between the extinction coefficient and the scattering coefficient is approximated and formulated on the basis of the known target information, and used. Therefore, there is a problem that a measurement physical property parameter is erroneously calculated in a case where accuracy of a measured value is low, or in a case where the target is different from an assumed one and unknown. By using the method of the present disclosure, it is not necessary to formulate the relationship between the extinction coefficient and the scattering coefficient, and the problem of the conventional laser radar device can be solved.

<Modification>

Hereinafter, a modification of the first embodiment will be described. As a method for generating a pulse laser, not only a method for pulsing a continuous wave laser but also any one of general methods such as a method for directly generating a pulse wave laser such as a Q-switched laser or a mode synchronization laser, or a combination thereof may be used. As a method for generating an intensity modulation pulse, a method for generating an intensity modulation pulse using an electrolytic absorption modulator, an electro-optical crystal, an optical block, those similar to these, or an intensity modulator created using these, a method for generating a pseudo intensity modulation pulse by directly exciting a light source with an electrical signal pulse train, a method for generating a pseudo intensity modulation pulse by dividing a pulse laser with a beam splitter, delaying one pulse, and multiplexing the pulses again, a method for generating a pseudo intensity modulation pulse by disposing a wavelength conversion crystal in a resonator in which a reflectance is lowered only on one side mirror, and the like may be used.

Although the direct detection system is assumed in the light detection unit, the technology of the present disclosure may be applied to a coherent lidar, a differential absorption lidar, and a double polarization type lidar as long as an intensity modulation pulse is used as transmission light. In a case of application to the coherent lidar, since a target moving speed can be calculated in addition to physical property information of a target, it is possible to measure many parameters with higher accuracy. In a case of application to the differential absorption lidar, the light source unit outputs an intensity modulation pulse having a first wavelength and an intensity modulation pulse having a second wavelength different from the first wavelength, and the signal processing unit can further calculate an absorption wavelength and a concentration of a target as physical property information of the target from a reception signal intensity ratio between reception light having the first wavelength and reception light having the second wavelength. In a case of application to the double polarization type lidar, the light source unit outputs an intensity modulation pulse having two orthogonal polarization states, and the signal processing unit can further calculate a particle shape of a target as physical property information of the target from a reception signal intensity ratio by the two polarizations. The optical system is based on the transmission and reception optical system, but the optical system may have a configuration of a transmission and reception separate axis. In a case of the transmission and reception separate axis, a telescope (not illustrated) different from the telescope 9 is connected to the reception side optical system 10, and the transmission and reception separation unit 8 and the reception side optical system 10 are not connected to each other. Such a configuration of the transmission and reception separate axis is general and does not affect the operation of the first embodiment.

### Second Embodiment

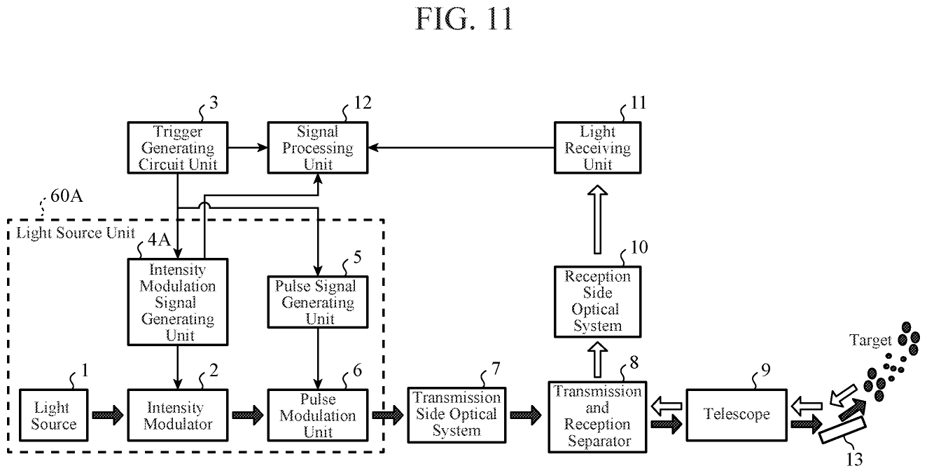

Hereinafter, a laser radar device according to a second embodiment will be described with reference to FIGS. 11 to 13.

<Configuration>

As illustrated in FIG. 11, an overall configuration of the laser radar device according to the second embodiment is similar to the configuration of the laser radar device of the first embodiment illustrated in FIG. 1. As illustrated in FIG. 11, in the laser radar device of the second embodiment, a light source unit 60A includes a light source 1, an intensity modulator 2, an intensity modulation signal generating unit 4A, a pulse signal generating unit 5, and a pulse modulation unit 6. In the laser radar device according to the second embodiment, a configuration of the intensity modulation signal generating unit 4A included in the light source unit 60A is different from that of the intensity modulation signal generating unit 4 of the first embodiment.

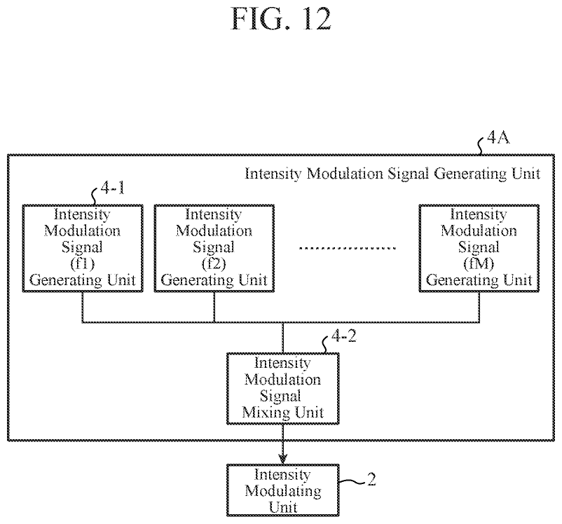

As illustrated in FIG. 12, the intensity modulation signal generating unit 4A includes an intensity modulation signal (f) generating unit group 4-1 including M intensity modulation signal (f) generating units and an intensity modulation signal mixing unit 4-2 connected to the intensity modulation signal (f) generating unit group 4-1.

The intensity modulation signal (f) generating unit group 4-1 generates M intensity modulation signals having different frequencies. The intensity modulation signal (f) generating unit group 4-1 includes a function generator, an FPGA, a reference signal generator, and an RF frequency signal generator such as a multiplier or a divider.

The intensity modulation signal mixing unit 4-2 mixes the M intensity modulation signals from the intensity modulation signal (f) generating unit group 4-1. The intensity modulation signal mixing unit 4-2 includes, for example, an RF frequency mixer.

<Operation>

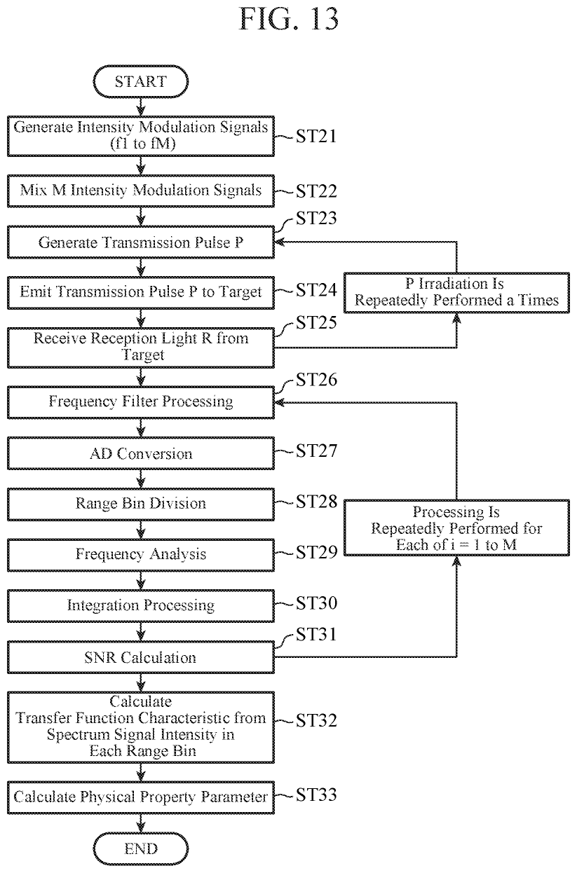

In the first embodiment, a pulse is generated by intensity-modulating laser light at a certain intensity modulation frequency fk, and each of M kinds of pulses is emitted a times for integration. On the other hand, in the second embodiment, M intensity modulation signals having different frequencies (f1 to fM) are simultaneously applied to a transmission pulse, and the transmission pulse is emitted a times for integration. The operation of the second embodiment is different from that of the first embodiment in this point. In the other points, the operation of the second embodiment is similar to the operation of the first embodiment. The difference point will be described with reference to FIG. 13.

In step ST21, the intensity modulation signal (f) generating unit group 4-1 generates intensity modulation signals having frequencies of f1 to fM on the basis of a trigger signal, and outputs the M intensity modulation signals having frequencies of f1 to fM to the intensity modulation signal mixing unit 4-2 and the signal processing unit 12.

In step ST22, the intensity modulation signal mixing unit 4-2 mixes the M intensity modulation signals. The intensity modulation signal mixing unit 4-2 outputs the mixed signal to the intensity modulator 2. The intensity modulation signal mixing unit 4-2 may output the mixed signal to the signal processing unit 12. Following the operation by the intensity modulation signal mixing unit 4-2, the intensity modulator 2 intensity-modulates continuous wave laser light having a single frequency from the light source 1 with the mixed intensity modulation signal, and outputs the intensity-modulated continuous wave laser light to the pulse modulation unit 6.

In step ST23, the pulse modulation unit 6 pulse-modulates the intensity-modulated continuous wave laser light into pulse light P on the basis of the pulse signal from the pulse signal generating unit 5, and outputs the pulse light P to the transmission side optical system 7.

In step ST24, the telescope 9 emits the pulse light P converted into light having a predetermined beam diameter and beam divergence angle by the transmission side optical system 7 toward the target via the scanner 13. The target is irradiated with the transmission light P emitted to the atmosphere, and reception light R is generated when the transmission light P is scattered by the target.

In step ST25, the telescope 9 receives the reception light R through an opening, and outputs the reception light R to the transmission and reception separator 8. The reception light R is transmitted to the reception side optical system 10 via the transmission and reception separator 8. The reception light R is converted into light having a predetermined beam diameter and beam divergence angle by the reception side optical system 10 and then transmitted to the light receiving unit 11. The reception light R is converted into a reception electrical signal by the light receiving unit 11, and the reception electrical signal is transmitted to the signal processing unit 12.

The laser radar device repeats the transmission and reception processing in steps ST23 to ST25 described above a times.

The processing in steps ST26 to ST33 is similar to the processing in steps ST9 to ST16 in the first embodiment.

<Modification>

In the above description, M different intensity modulation signal generating units are prepared. Furthermore, for X and Y where M=XY, by preparing X different intensity modulation signal generating units, applying X intensity modulations to one pulse, and performing irradiation with a pulse Y times while changing the intensity modulation frequency, a transfer function characteristic of a target for M different intensity modulations can be calculated with the Y pulse. The number of signal generators and the number of times of pulse irradiation may be changed appropriately.

### Third Embodiment

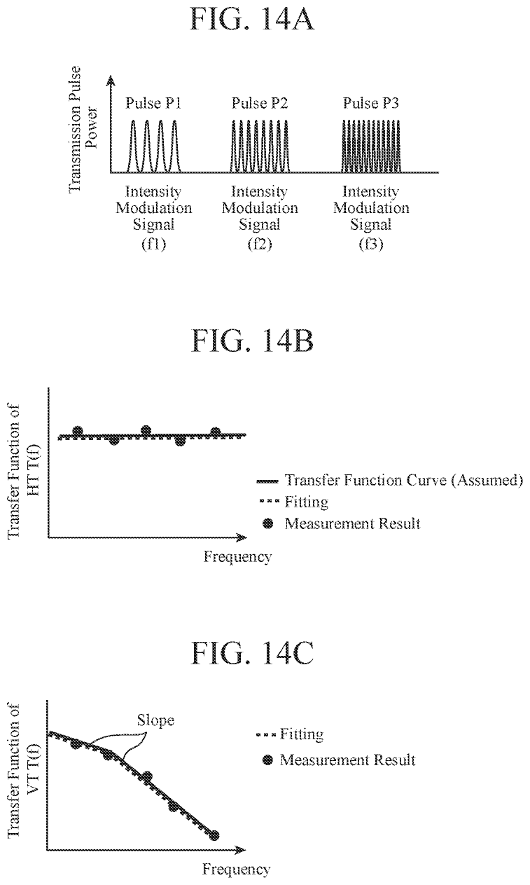

Hereinafter, a laser radar device according to a third embodiment will be described with reference to FIGS. 14 to 17. In the configurations of the first and second embodiments, an error may occur in a calculated transfer function characteristic due to non-uniformity of pulse power or an intensity modulation degree between intensity modulation pulses generated when intensity modulation with a frequency fk is applied to each pulse Pk. The description will be made in a different paragraph.

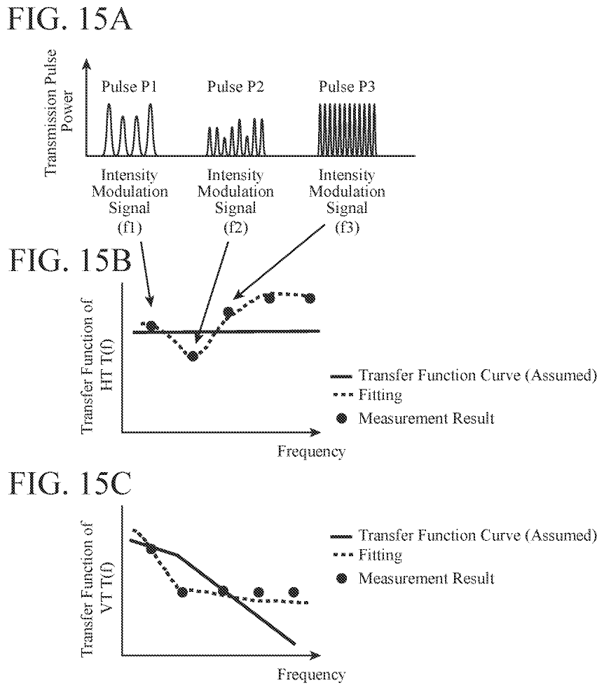

In a case where a difference in a pulse parameter of each intensity modulation pulse is small as illustrated in FIG. 14A, a transfer function (dotted line) evaluated from a reception signal SNR from a target substantially coincides with a true value (solid line) as illustrated in FIG. 14B or 14C. On the other hand, for example, in a case where a difference in a pulse parameter of each intensity modulation pulse is large as illustrated in FIG. 15A, a transfer function (dotted line) evaluated from a reception signal SNR from a target does not coincide with a true value (solid line) as illustrated in FIG. 15B or 15C, which leads to miscalculation. Here, the pulse parameter represents an envelope shape of each intensity modulation pulse, a peak component constituting each intensity modulation pulse, an intensity modulation frequency applied to a light pulse, or a parameter similar thereto. In addition, the difference in a pulse parameter represents a difference in an envelope shape of each intensity modulation pulse, a peak component constituting each intensity modulation pulse, an intensity modulation frequency applied to a light pulse, or a parameter similar thereto with respect to an ideal value.

Accordingly, the laser radar device of the third embodiment is configured to calculate a more accurate transfer function from a detected SNR by monitoring some of intensity modulation pulse signals and adding control in such a manner that a pulse parameter of each of pulses (P1 to PM) is optimized.

<Configuration>

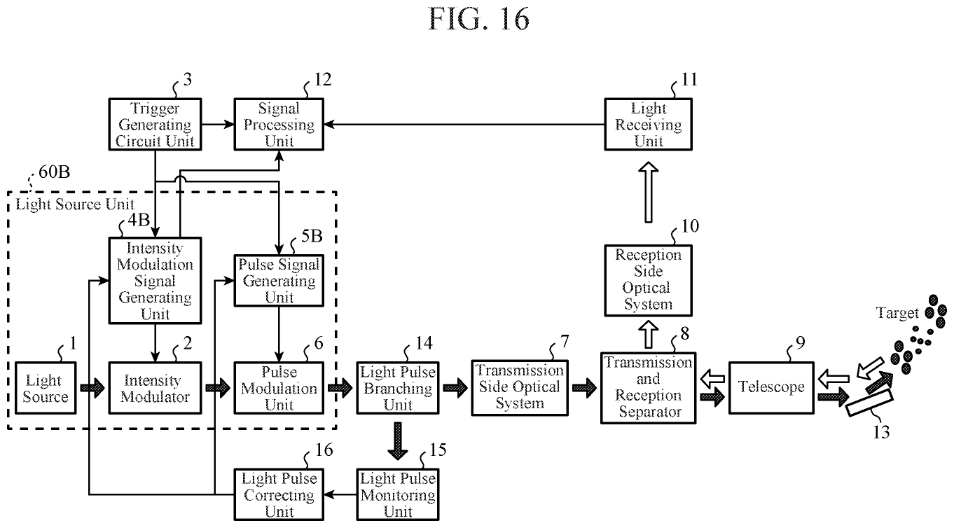

The laser radar device according to the third embodiment is different from the laser radar device of the first embodiment in the following points. That is, as illustrated in FIG. 16, the laser radar device according to the third embodiment further includes a light pulse branching unit 14, a light pulse monitoring unit 15, and a light pulse correcting unit 16. The light pulse branching unit 14 is disposed between a pulse modulation unit 6 and a transmission side optical system 7. The light pulse monitoring unit 15 is disposed at a subsequent stage of the light pulse branching unit 14. The light pulse correcting unit 16 is disposed at a subsequent stage of the light pulse monitoring unit 15, and is connected to an intensity modulation signal generating unit 4B and a pulse signal generating unit 5B. Note that a light source 1, an intensity modulator 2, the intensity modulation signal generating unit 4B, the pulse signal generating unit 5B, and the pulse modulation unit 6 constitute a light source unit 60B. Note that the laser radar device according to the second embodiment may be modified in such a manner that the light pulse branching unit 14, the light pulse monitoring unit 15, and the light pulse correcting unit 16 are added to the laser radar device according to the second embodiment.

The light pulse branching unit 14 branches some of the intensity modulation pulses generated by the pulse modulation unit 6, and outputs the branched some pulses to the light pulse monitoring unit 15.

The light pulse monitoring unit 15 converts a light pulse signal into an electrical signal.

The light pulse correcting unit 16 compares the electrical signal from the light pulse monitoring unit 15 with an ideal intensity modulation pulse waveform held in advance, and outputs a feedback signal to the intensity modulation signal generating unit 4 and the pulse signal generating unit 5 in such a manner that the waveform of the pulse output from the pulse modulation unit is ideal. For example, the light pulse correcting unit 16 outputs a feedback signal for controlling pulse power and a modulation intensity of a transmission pulse.

<Operation>

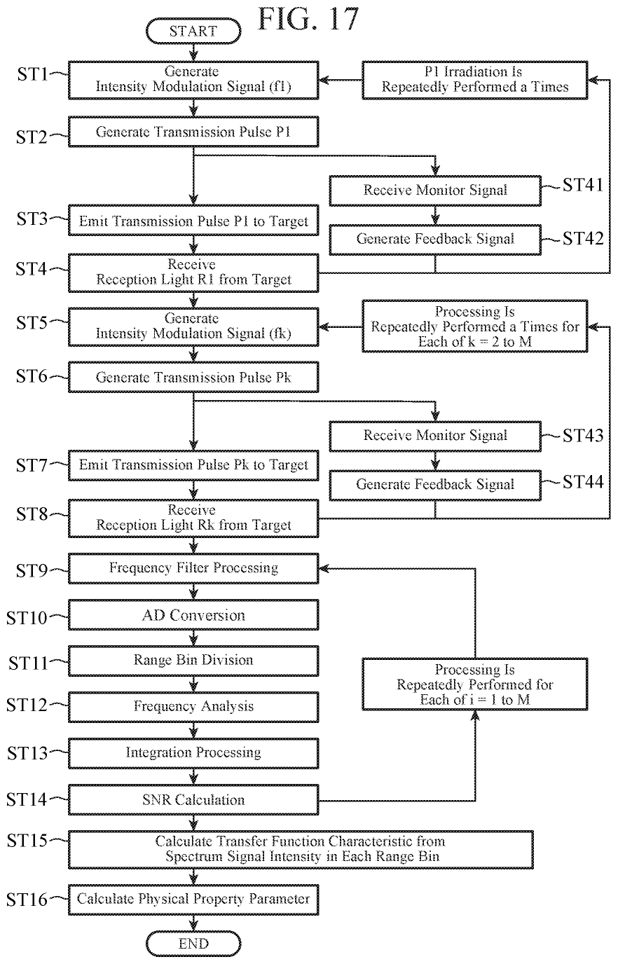

Next, operation of the laser radar device of the third embodiment will be described with reference to FIG. 17. The operation of the laser radar device of the third embodiment is different from the operation of the laser radar device of the first embodiment in that processing in steps ST41, ST42, ST43, and ST44 is added. In order to omit redundant description, only points different from the operation of the first embodiment will be described.

In step ST41, the light pulse monitoring unit 15 receives a light pulse signal as a monitor signal branched from the light pulse branching unit 14, and converts the received light pulse signal into an electrical signal.

In step ST42, the light pulse correcting unit 16 compares a waveform of the electrical signal from the light pulse monitoring unit 15 with an ideal intensity modulation pulse waveform held in advance, and outputs a feedback signal to the intensity modulation signal generating unit 4 and the pulse signal generating unit 5 in such a manner that a deviation between these waveforms is suppressed, that is, the waveform of the pulse output from the pulse modulation unit is ideal.

In step ST1 after the feedback signal is generated, the intensity modulation signal generating unit 4B generates an intensity modulation signal having a frequency f1 on the basis of the feedback signal, and outputs the generated intensity modulation signal having the frequency f1 to the intensity modulator 2 and the signal processing unit 12. Subsequently, the intensity modulator 2 intensity-modulates continuous wave laser light having a single frequency from the light source 1 with the intensity modulation signal having the frequency f1 generated on the basis of the feedback signal, and outputs the intensity-modulated continuous wave laser light to the pulse modulation unit 6.

In step ST2 after the feedback signal is generated, the pulse modulation unit 6 pulse-modulates the intensity-modulated continuous wave laser light on the basis of the pulse signal generated on the basis of the feedback signal from the pulse signal generating unit 5.

Similarly, in a case of a pulse Pk (k=2 to M), in step ST43, a monitor signal is received by the light pulse monitoring unit 15, and in ST44, a feedback signal is generated. An intensity modulation signal having a frequency fk based on the feedback signal is generated (step ST5), and a pulse Pk based on the feedback signal is generated.

<Effects>

According to the laser radar device according to the third embodiment, it is possible to suppress a difference of pulse power or an intensity modulation degree of each intensity modulation pulse generated when intensity modulation with a frequency fk is applied to each pulse Pk with respect to an ideal value, and therefore, it is possible to prevent an error from occurring in a calculated transfer function characteristic.

### Fourth Embodiment

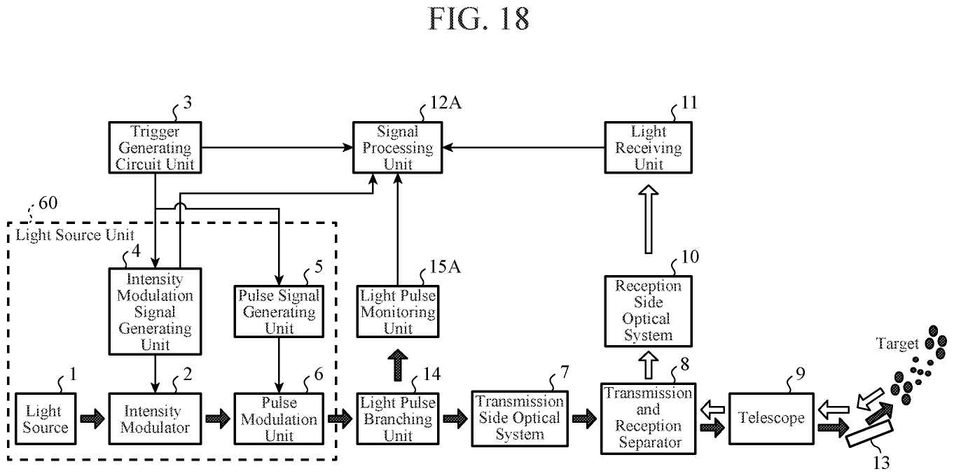

Hereinafter, a laser radar device according to a fourth embodiment will be described with reference to FIGS. 18 to 20. Similarly to the laser radar device according to the third embodiment, an object of the laser radar device according to the fourth embodiment is to correct an error in a transfer function characteristic calculated from non-uniformity of pulse power or an intensity modulation degree between intensity modulation pulses generated when intensity modulation with a frequency fk is applied to each pulse Pk. A method for achieving this object is different between the laser radar device according to the fourth embodiment and the laser radar device according to the third embodiment. In short, the laser radar device according to the fourth embodiment is configured to monitor some of intensity modulation pulse signals, to observe a parameter of an actual intensity modulation pulse with respect to an ideal intensity modulation pulse parameter, to calculate uncertainty of a reception signal such as an error of a transfer function that can occur on the basis of the information, and to calculate a more accurate transfer function by correcting a detected SNR using the information. Details will be described below.

<Configuration>

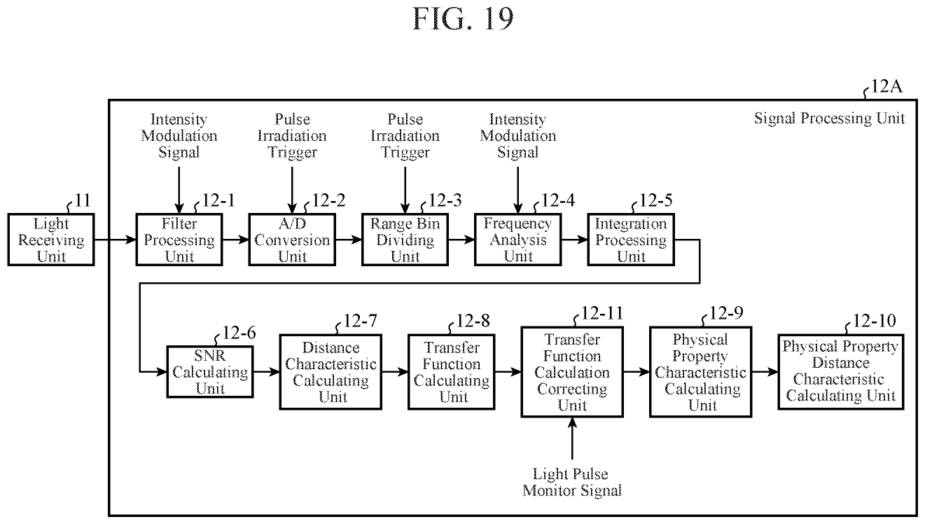

The laser radar device according to the fourth embodiment is different from the laser radar device of the first embodiment in the following points. That is, as illustrated in FIG. 18, the laser radar device according to the fourth embodiment further includes a light pulse branching unit 14 and a light pulse monitoring unit 15A. The light pulse branching unit 14 is disposed between a pulse modulation unit 6 and a transmission side optical system 7. The light pulse monitoring unit 15A is disposed at a subsequent stage of the light pulse branching unit 14. The light pulse monitoring unit 15A is electrically connected to a signal processing unit 12A. The light pulse monitoring unit 15A converts a light pulse signal into an electrical signal, and supplies the converted electrical signal to the signal processing unit 12A as a light pulse monitor signal. In addition, as illustrated in FIG. 19, the signal processing unit 12A further includes a transfer function calculation correcting unit 12-11. As an example, the transfer function calculation correcting unit 12-11 is disposed between a transfer function calculating unit 12-8 and a physical property characteristic calculating unit 12-9 in the signal processing unit 12. Note that a light source 1, an intensity modulator 2, an intensity modulation signal generating unit 4, a pulse signal generating unit 5, and a pulse modulation unit 6 constitute a light source unit 60 similarly to the case of the first embodiment. Note that the laser radar device according to the second embodiment may be modified in such a manner that the light pulse branching unit 14, the light pulse monitoring unit 15A, and the transfer function calculation correcting unit 12-11 are added to the laser radar device according to the second embodiment.

The light pulse branching unit 14 branches some of the intensity modulation pulses generated by the pulse modulation unit 6, and outputs the branched some pulses to the light pulse monitoring unit 15A.

The light pulse monitoring unit 15A converts the light pulse signal into an electrical signal (light pulse monitor signal).

The transfer function calculation correcting unit 12-11 compares the electrical signal (light pulse monitor signal) from the light pulse monitoring unit 15A with information regarding such an optimum driving condition of an intensity modulation pulse that a spectral characteristic of a reception signal from a target having a uniform frequency response characteristic of the reception signal is uniform, and corrects the output from the transfer function calculating unit 12-8. The information includes an ideal intensity modulation pulse waveform.

<Operation>

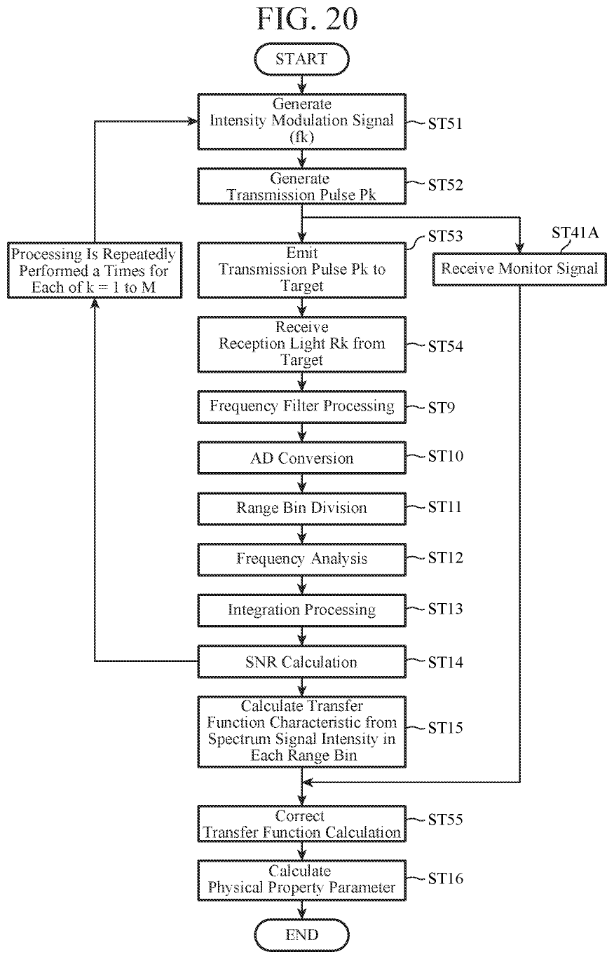

Next, operation of the laser radar device according to the fourth embodiment will be described with reference to FIG. 20. The operation of the laser radar device of the fourth embodiment is different from the operation of the laser radar device of the third embodiment in that processing in step ST55 is added, and the processing performed after the step of receiving a monitor signal (ST41A) is the processing in step ST55. In order to omit redundant description, only points different from the operation of the third embodiment will be described.

Note that steps ST51 to ST54 in FIG. 20 are substantially similar to steps ST1 to ST8 in FIG. 17 according to the third embodiment. A reason why the word “substantially” is used is that the processing illustrated in FIG. 20 is different from the processing illustrated in FIG. 17 in that the processing of generating a feedback signal on the basis of a monitor signal (steps ST41 to ST44) is omitted. Note that the laser radar device of the fourth embodiment may also perform processing of generating a feedback signal on the basis of a monitor signal (steps ST41 to ST44) similarly to the third embodiment.

In step ST41A of FIG. 20, the light pulse monitoring unit 15A receives a light pulse signal as a monitor signal branched from the light pulse branching unit 14, converts the received light pulse signal into an electrical signal, and supplies the converted electrical signal to the transfer function calculation correcting unit 12-11 of the signal processing unit 12A as a light pulse monitor signal.

In step ST55, the transfer function calculation correcting unit 12-11 compares a waveform of the electrical signal (light pulse monitor signal) from the light pulse monitoring unit 15 acquired in step ST41A with an ideal intensity modulation pulse waveform held in advance, predicts or calculates an error of a transfer function calculation result that can be caused by a deviation between these waveforms, and corrects the error, thereby correcting the transfer function.

In the present embodiment, the correction by the transfer function calculation correcting unit 12-11 is performed after the integration processing and after the SNR calculation. However, the present embodiment may be modified in such a manner that the correction by the transfer function calculation correcting unit 12-11 is performed before the integration processing or before the SNR calculation. In a case where the correction by the transfer function calculation correcting unit 12-11 is performed before the integration processing, the transfer function calculation correcting unit 12-11 is disposed between the frequency analysis unit 12-4 and the integration processing unit 12-5, and the processing in step ST55 is performed immediately after step ST12. In a case where the correction by the transfer function calculation correcting unit 12-11 is performed before the SNR calculation, the transfer function calculation correcting unit 12-11 is disposed between the integration processing unit 12-5 and the SNR calculating unit 12-6, and the processing in step ST55 is performed immediately after step ST13.

<Effects>

According to the laser radar device according to the fourth embodiment, it is possible to correct an error of a transfer function characteristic calculated from non-uniformity of pulse power or an intensity modulation degree between intensity modulation pulses generated when intensity modulation with a frequency fk is applied to each pulse Pk, and to more accurately calculate a physical property characteristic.

Note that the embodiments can be combined, and each of the embodiments can be appropriately modified or omitted.

### INDUSTRIAL APPLICABILITY

The laser radar device of the present disclosure can be used as a laser radar device for calculating a physical property parameter such as an extinction coefficient of a target.

### REFERENCE SIGNS LIST

1: light source, 2: intensity modulator, 3: trigger generating circuit unit, 4: intensity modulation signal generating unit, 4-1: intensity modulation signal generating unit group, 4-2: intensity modulation signal mixing unit, 4A: intensity modulation signal generating unit, 4B: intensity modulation signal generating unit, 5: pulse signal generating unit, 5B: pulse signal generating unit, 6: pulse modulation unit, 7: transmission side optical system, 8: transmission and reception separator, 9: telescope, 10: reception side optical system, 11: light receiving unit, 12: signal processing unit, 12A: signal processing unit, 12-1: filter processing unit, 12-2: A/D conversion unit, 12-3: range bin dividing unit, 12-4: frequency analysis unit, 12-5: integration processing unit, 12-6: SNR calculating unit, 12-7: distance characteristic calculating unit, 12-8: transfer function calculating unit, 12-9: physical property characteristic calculating unit, 12-10: physical property distance characteristic calculating unit, 12-11: transfer function calculation correcting unit, 13: scanner, 14: light pulse branching unit, 15: light pulse monitoring unit, 15A: light pulse monitoring unit, 16: light pulse correcting unit, 60: light source unit (light source circuit), 60A: light source unit (light source circuit), 60B: light source unit (light source circuit), 100a: processing circuit, 100b: processor, 100c: memory

1. A laser radar device comprising:
a light source circuit to output a plurality of intensity modulation pulses by periodically intensity-modulating laser light using intensity modulation signals having different frequencies;
a telescope to transmit the plurality of intensity modulation pulses to a target and to receive reflected light from the target as reception light;
a light receiver to generate a reception electrical signal by photoelectrically converting the reception light; and
a signal processor to calculate a distance and an extinction coefficient of the target on a basis of the reception electrical signal.

2. The laser radar device according to claim 1, wherein
the light source circuit generates the plurality of intensity modulation pulses by generating a plurality of intensity modulation signals having different frequencies over time or simultaneously generating and mixing a plurality of intensity modulation signals having different frequencies.

3. The laser radar device according to claim 2, wherein
the light source circuit outputs the intensity modulation signals having different frequencies to the signal processor, and
the signal processor generates a spectrum signal by performing frequency analysis on the reception electrical signal using information of a frequency used for generation of any one of the plurality of intensity modulation pulses, and detects a frequency and a signal-to-noise ratio of the spectrum signal.

4. The laser radar device according to claim 3, wherein
the signal processor performs frequency analysis on the reception electrical signal using information of frequencies used for generation of two or more types of intensity modulation pulses out of the plurality of intensity modulation pulses, generates a plurality of spectra related to reception light reflected from the target that is in the same range, and analyzes frequency dependence of the signal-to-noise ratios of the plurality of spectra.

5. The laser radar device according to claim 4, wherein
the signal processor analyzes transfer function characteristics of the target that is in the same range from the frequency dependence of the signal-to-noise ratios.

6. The laser radar device according to claim 5, wherein
an extinction coefficient of the target that is in the same range is evaluated on a basis of the transfer function characteristics.

7. The laser radar device according to claim 6, wherein
the light source circuit outputs an intensity modulation pulse having a first wavelength and an intensity modulation pulse having a second wavelength different from the first wavelength, and
the signal processor calculates an absorption wavelength and a concentration of the target from a reception signal intensity ratio between reception light having the first wavelength and reception light having the second wavelength.

8. The laser radar device according to claim 6, wherein
the light source circuit outputs an intensity modulation pulse having two orthogonal polarization states, and
the signal processor evaluates a particle shape of the target from a reception signal intensity ratio by the two polarizations.

9. The laser radar device according to claim 6, further comprising:
a light pulse monitor to photoelectrically convert the intensity modulation pulse generated by the light source circuit; and
a light pulse corrector to output a feedback signal for controlling pulse power and a modulation intensity of a transmission pulse on a basis of an electrical signal from the light pulse monitor.

10. The laser radar device according to claim 9, wherein
the light pulse corrector holds an ideal intensity modulation pulse waveform, calculates a deviation by comparing a waveform of an electrical signal from the light pulse monitor with the ideal intensity modulation pulse waveform, and outputs a feedback signal to the light source circuit so as to suppress the deviation.

11. The laser radar device according to claim 6, further comprising a light pulse monitor to photoelectrically convert the intensity modulation pulse generated by the light source circuit, wherein
the signal processor is connected to the light pulse monitor to perform correction on a basis of an electrical signal from the light pulse monitor.

12. The laser radar device according to claim 11, wherein
the signal processor holds, in advance, information regarding such an optimum driving condition of an intensity modulation pulse that a spectral characteristic of a reception signal from another target having a uniform frequency response characteristic of the reception signal is uniform, and corrects uncertainty of the reception signal generated by the intensity modulation transmission pulse by comparing the information with an electrical signal from the light pulse monitor.
